(19) United States
(12) Patent Application Publication
(10) Pub. No.: US 2003/0184529 A1
(43) Pub. Date: Oct. 2, 2003

(54) Input device for an electronic appliance

(75) Inventors: Chung-Chi Chien, Taipei City (TW); Wu-Yung Chen, Taipei City (TW)

Correspondence Address: BACON & THOMAS, PLLC, 625 SLATERS LANE, FOURTH FLOOR, ALEXANDRIA, VA, 22314

(73) Assignee: Compal Electronics, Inc., Taipei City (TW)

(21) Appl. No.: 10/108,507

(22) Filed: Mar. 29, 2002

(51) Int. Cl. G09G 5/00

(52) U.S. Cl. 345/179

(57) ABSTRACT

An input device for use with an electronic appliance includes an accommodating unit adapted to be mounted within the electronic appliance and confining an elongated accommodating chamber. An input unit is received removably in the accommodating chamber. A biasing unit is mounted in the accommodating unit, and biases the input unit to move in a direction outwardly of the accommodating chamber. A retaining unit is mounted on the accommodating unit, and is normally disposed in an engaging position in which the retaining unit engages the input unit when the latter is received in the accommodating chamber. The retaining unit is operable to move from the engaging position to a non-engaging position, in which the retaining unit is disengaged from the input unit to permit ejection of the input unit from the accommodating chamber due to biasing action of the biasing unit.

### BACKGROUND OF THE INVENTION

1. Field of the Invention

The present invention relates to an input device for an electronic appliance, more particularly to an input device which can be easily operated so as to be ejected from an electronic appliance.

2. Description of the Related Art

A modern small-size electronic appliance, such as a personal digital assistant (PDA), is typically used with an input member, such as a touch pen, to permit the input of commands or information into the electronic appliance by simply touching certain areas on the PDA screen via the touch pen.

FIG. 1 shows a conventional PDA with a touch pen 91. The touch pen 91 engages and is received in a receiving groove 921 formed in an outer side wall of the PDA main body 92, and is removable from the engaging groove 921 for use. It is noted that the touch pen 91 is susceptible to loosen from the receiving groove 921 and can be untimely released from the receiving groove 921 after the PDA has been in use for a period of time.

Moreover, to facilitate gripping of the touch pen 91, the touch pen 91 is formed to have a sufficient length. This undesirably limits the minimum length of the receiving groove 921, and thus the size of the PDA main body 92. There exists a problem when it is desired to further reduce the size of the PDA.

### SUMMARY OF THE INVENTION

Therefore, an object of the present invention is to provide an input device which is easily operable so as to be ejected from an electronic appliance.

Another object of the present invention is to provide an input device with a variable length.

According to one aspect of the present invention, an input device for use with an electronic appliance, which has an outer side wall formed with an access hole, includes an accommodating unit, an input unit, a biasing unit, and a retaining unit. The accommodating unit confines an elongated accommodating chamber and is adapted to be mounted within the electronic appliance such that the accommodating chamber is aligned and communicated with the access hole. The input unit is received removably in the accommodating chamber of the accommodating unit. The biasing unit is mounted in the accommodating unit and biases the input unit to move in a direction outwardly of the accommodating chamber. The retaining unit is mounted on the accommodating unit, and is normally disposed in an engaging position in which the retaining unit engages the input unit when the input unit is received in the accommodating chamber for retaining the input unit in the accommodating chamber against biasing action of the biasing unit. The retaining unit is operable to move from the engaging position to a non-engaging position, in which the retaining unit is disengaged from the input unit to permit ejection of the input unit from the accommodating chamber due to the biasing action of the biasing unit.

According to another aspect of the present invention, an electronic appliance includes a main body, an accommodating unit, an input unit, a biasing unit and a retaining unit. The main body has an outer side wall formed with an access hole. The accommodating unit is mounted within the main body, and confines an elongated accommodating chamber that is aligned and communicated with the access hole. The input unit is received removably in the accommodating chamber of the accommodating unit. The biasing unit is mounted in the accommodating unit for biasing the input unit to move in a direction outwardly of the accommodating chamber. The retaining unit is mounted on the accommodating unit, and is normally disposed in an engaging position in which the retaining unit engages the input unit when the input unit is received in the accommodating chamber for retaining the input unit in the accommodating chamber against biasing action of the biasing unit. The retaining unit is operable to move from the engaging position to a non-engaging position, in which the retaining unit is disengaged from the input unit to permit ejection of the input unit from the accommodating chamber due to the biasing action of the biasing unit.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional PDA with a touch pen;

FIG. 2 is a perspective view showing a PDA incorporating an input device of a preferred embodiment according to the present invention;

FIG. 3 is an exploded perspective view of the input device of the preferred embodiment;

FIG. 4 is a fragmentary perspective view of the preferred embodiment when installed in the PDA;

FIG. 5 is an exploded perspective view showing an input unit of the preferred embodiment;

FIG. 6 shows the input unit in a non-extended state;

FIG. 7 shows the input unit in an extended state;

FIG. 8 is a partly sectional view of the input device of the preferred embodiment when the input unit is received in the PDA; and

FIG. 9 is a partly sectional view of the input device of the preferred embodiment when a depressing button is depressed to eject the input unit from the PDA.

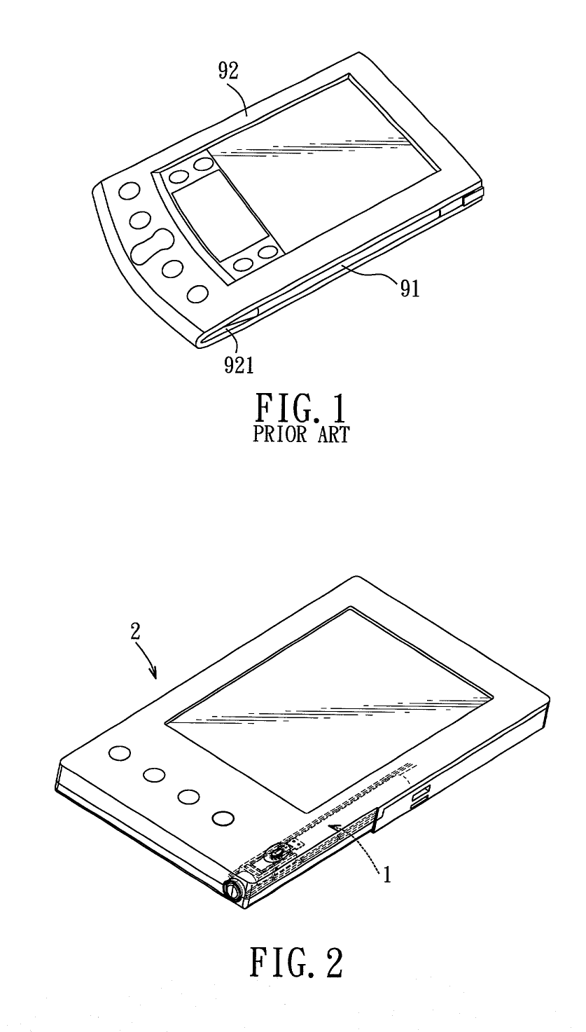

### DETAILED DESCRIPTION OF THE PREFERRED EMBODIMENT

Referring to FIG. 2, the preferred embodiment of the input device 1 according to this invention is incorporated into a personal digital assistant (PDA), and is installed in a main body 2 of the PDA. The input device 1 may be used in other electronic appliances, such as a notebook computer.

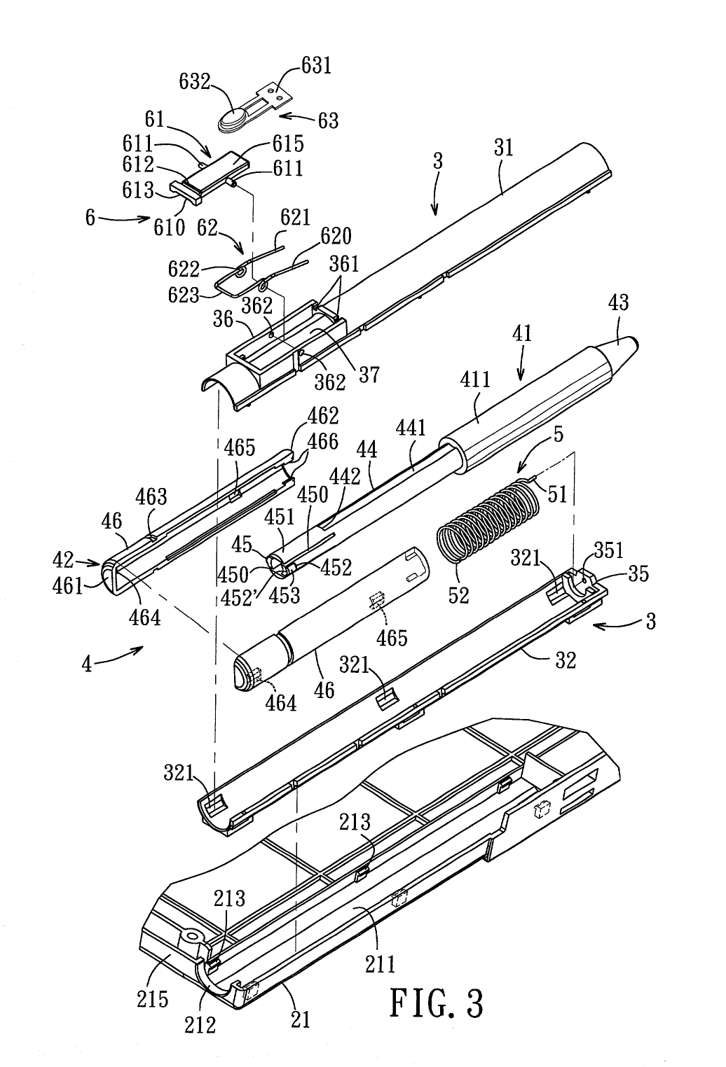

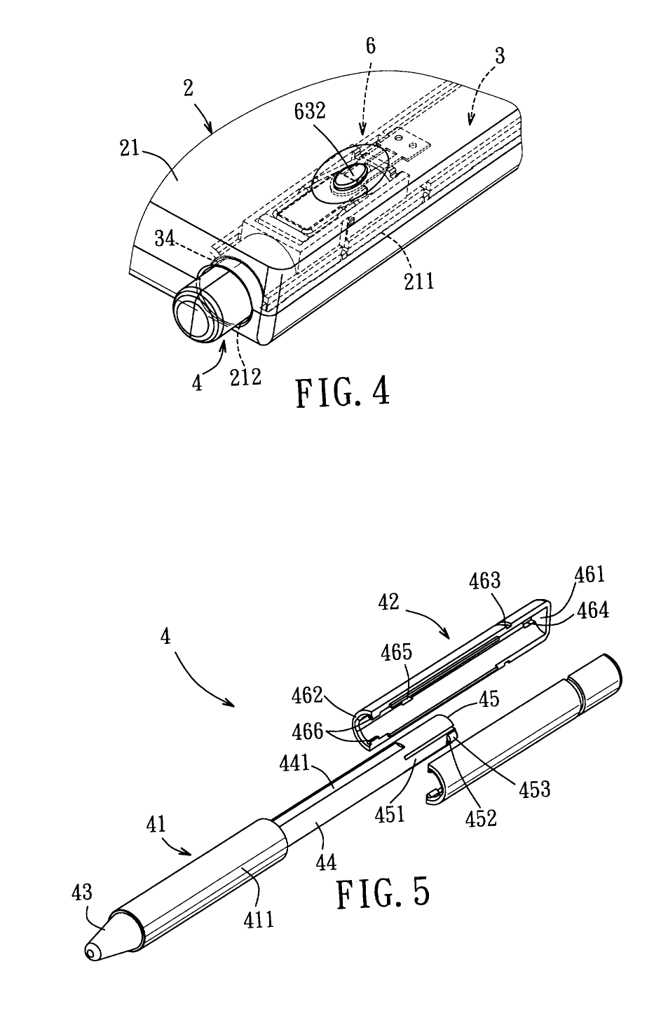

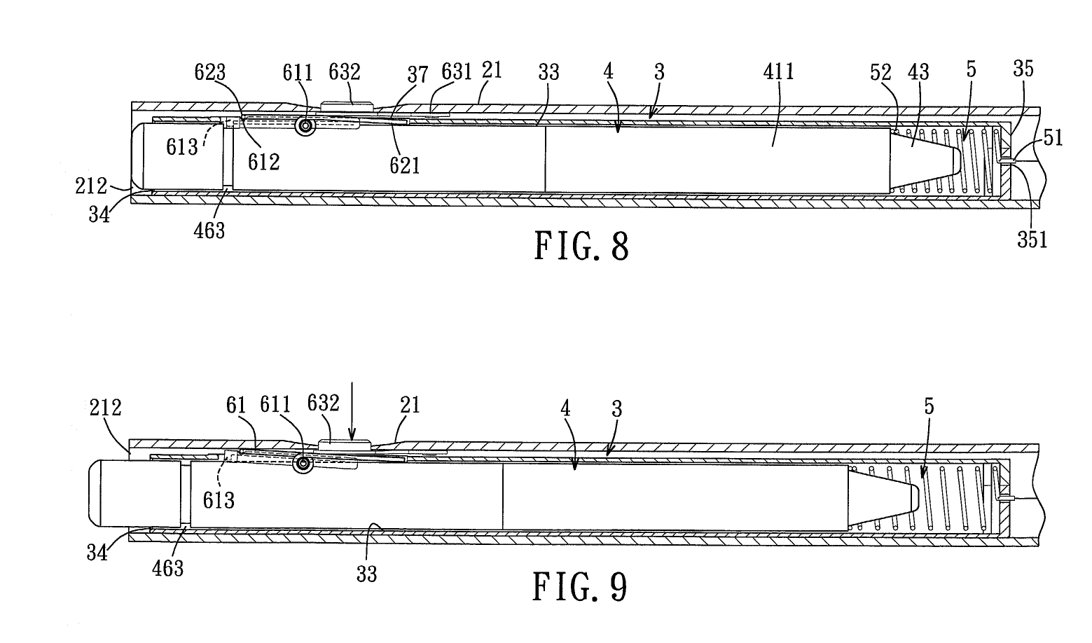

Referring to FIGS. 3, 4 and 8, the input device 1 mainly includes an accommodating unit 3, a telescopic input unit 4, a biasing unit 5, and a retaining unit 6. The accommodating unit 3 is formed as a tubular casing with upper and lower casing parts 31, 32 which cooperatively confine a cylindrical accommodating chamber 33 (see FIG. 8) with a circular open end 34 and a closed end 35 opposite to the open end 34. The upper casing 31 is formed with a rectangular radial opening 37 communicated with the accommodating chamber 33 and defined by a rectangular wall that projects upwardly from the upper casing part 31. The lower casing part 32 is formed with a spring positioning hole 351 at an inner wall surface of an end wall of the closed end 35. The upper and lower casing parts 31, 32 of the accommodating unit 3 are received within an elongated receiving cavity 211 formed in a housing 21 of the PDA main body 2. The housing 21 of the PDA main body 2 further has an outer side wall 215 formed with a circular access hole 212 aligned and communicated with the receiving cavity 211 and the accommodating chamber 33. As shown, the PDA main body 2 is further formed with pairs of locking projections 213 within the cavity 211 for engaging pairs of locking holes 321 in the lower casing part 32 to retain the accommodating unit 3 stably within the receiving cavity 211 of the PDA main body 2.

The input unit 4 is in the form of a touch pen, and is insertible into and removable from the accommodating chamber 33 via the open end 34 of the accommodating unit 3 and the access hole 212 in the housing 21 of the PDA main body 2. The input unit 4 is used to enter commands or information into the electronic appliance, i.e., the PDA, by touching or writing on the screen (not shown) of the PDA via with a touch portion 43 formed on a front end thereof.

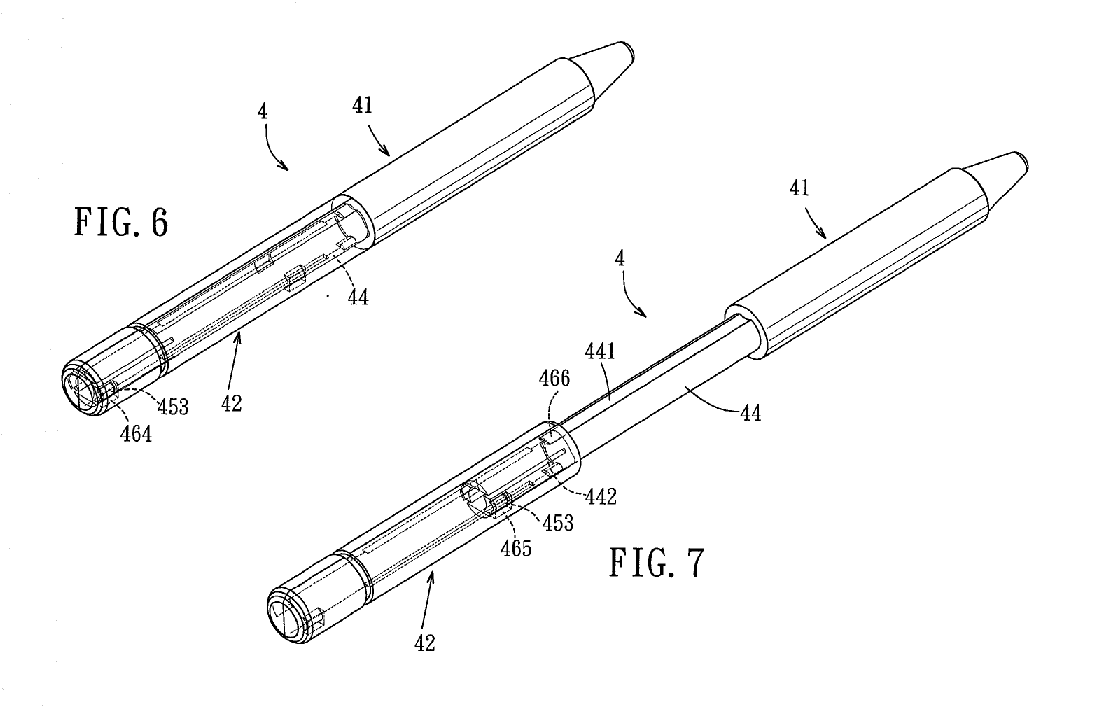

Referring to FIGS. 3 and 5, the input unit 4 includes an elongated main input body 41 with a cylindrical front section 411 formed with the touch portion 43 on one end, and a tubular rear section 44 extending rearwardly and coaxially from the front section 411. The rear section 44 has an outer surface formed with a pair of diametrically opposite and axially extending guiding grooves 441 (only one is shown), and has a distal rear end 45 formed with a plurality of angularly displaced and axially extending slits 450 which impart resiliency to the rear end 45 and which configure the rear end 45 of the rear section 44 into a plurality of resilient strips 451 that are resilient in radial directions. Each of an opposite pair of the resilient strips 451 is formed with a positioning protrusion 453 on an outer surface thereof. The positioning protrusion 453 has opposite inclined surfaces 452, 452′ which are inclined relative to an axis of the rear section 44 and which are opposite to each other along the axis of the rear section 44. The input unit 4 further includes a slide sleeve 42 which is sleeved slidably on the rear section 44 of the main input body 41. The slide sleeve 42 is composed of two elongated sleeve parts 46 that are secured to each other. The sleeve parts 46 of the slide sleeve 42 form a pair of diametrically opposite guiding blocks 466 on an inner surface of the slide sleeve 42 and at an open front end 462 of the slide sleeve 42. The inner surface of the slide sleeve 42 is further formed with an opposite pair of first positioning grooves 464 adjacent to a rear end wall 461 of the slide sleeve 42, and an opposite pair of second positioning grooves 465 proximate to the open front end 462 of the slide sleeve 42. The first positioning grooves 464 are displaced axially and respectively from and are aligned axially and respectively with the second positioning grooves 465. The guiding blocks 466 extend respectively into and are slidable along the guiding grooves 441 in the rear section 44 of the main input body 4 when the slide sleeve 42 is moved relative to the main input body 41. When the slide sleeve 42 is slid relative to the main input body 41 in a direction toward the front section 411 to a non-extended position, the first positioning grooves 464 engage the positioning protrusions 453 to retain the slide sleeve 42 releasably at the non-extended position, where the input unit 4 is defined with a shortest length, as shown in FIG. 6. When the slide sleeve 42 is slid relative to the main input body 41 in a direction away from the front section 411 to an extended position, the second positioning grooves 465 engage the positioning protrusions 453 to retain the slide sleeve 42 releasably at the extended position, where the input unit 4 is defined with a longest length which is suitable for gripping by the user, as shown in FIG. 7. The engagement between the guiding blocks 466 and the guiding grooves 441 serves to guide sliding movement of the slide sleeve 42 relative to the main input body 41, and ensures engagement between the positioning protrusions 453 and the first and second positioning grooves 464, 465 at the non-extended and extended positions, respectively. Due to the resiliency of the resilient strips 451 in radial directions, and due to the presence of the inclined surfaces 452, 452′ on the positioning protrusions 453, the positioning protrusions 453 are able to engage releasably a selected pair of the first and second positioning grooves 464, 465 by simply applying a pushing force to push the slide sleeve 42 toward the front section 411 to the non-extended position or a pulling force to pull the slide sleeve 42 away from the front section 411 to the extended position. The inner surface of the slide sleeve 42 at peripheries of the first positioning grooves 464 slides past one pair of the inclined surfaces 452 that face forwardly for disengaging the positioning protrusions 453 from the first positioning grooves 464 when the slide sleeve 42 is stretched from the non-extended position toward the extended position. The inner surface of the slide sleeve 42 at peripheries of the second positioning grooves 465 slides past another pair of the inclined surfaces 452′ that face rearwardly for disengaging the positioning protrusions 453 from the second positioning grooves 465 when the slide sleeve 42 is retracted from the extended position toward the non-extended position. Each of the guiding blocks 466 abuts against a rear periphery that defines a closed rear end 442 of a respective one of the guiding grooves 441, and engages the rear end 442 when the slide sleeve 42 is slid to the extended position, thereby preventing removal of the slide sleeve 42 from the main input body 41. The slide sleeve 42 further has an outer surface formed with an annular retaining groove 463 that extends therearound.

The biasing unit 5 is in the form of a coiled compression spring in the present embodiment, and is received in the accommodating chamber 33 proximate to the closed end 35. The biasing unit 5 has an anchoring leg 51 that extends into the spring positioning hole 351 in the lower casing part 32 of the accommodating unit 3. The biasing unit 5 is disposed around the touch portion 43 of the input unit 4 when the latter is received in the accommodating chamber 33, and has another end 52 opposite to the anchoring leg 51 and abutting against the front section 411 of the input unit 4, thereby applying a biasing force to the input unit 4 for biasing the input unit 4 to move in a direction outwardly of the accommodating chamber 33.

Referring to FIGS. 3 and 8, the retaining unit 6 includes a plate body 61 mounted in the radial opening 37 of the accommodating unit 3, and a biasing member 62. The plate body 61 has opposite first and second end portions 610, 615, and an intermediate portion between the first and second end portions 610, 615 and formed with an aligned pair of pivot shafts 611 that project from two longitudinal sides of the plate body 61. The pivot shafts 611 extend respectively into two pivot holes 362 formed in the rectangular wall 36 of the upper casing part 31 for mounting the plate body 61 pivotally on the upper casing part 31 in the radial opening 37. The first end portion 610 is formed with a spring receiving groove 612 on a top side, and a retaining projection 613 on a bottom side. The biasing member 62 is in the form of a bent metal rod with a generally U-shaped configuration, and includes parallel arms 620 which flank the longitudinal sides of the plate body 61, and a bridging section 623 transverse to and interconnecting the parallel arms 620. The parallel arms 620 have distal ends 621 and are each defined with a hole 622 for extension of a respective pivot shaft 611 therethrough. The distal ends 621 are received respectively in two notches 361 formed in an upper edge of the rectangular wall 36 on the upper casing part 31. The bridging section 623 is disposed on the top side of the plate body 61 and is received in the spring receiving groove 612. The bridging section 623 of the biasing member 62 normally abuts against the first end portion 610 of the plate body 61 and enables the biasing member 62 to apply a biasing force that biases the first end portion 610 of the plate body 61 toward the accommodating chamber 33 for moving the plate body 61 to an engaging position, in which the retaining projection 613 engages the retaining groove 463 in the input unit 4 when the input unit 4 is received in the accommodating chamber 33, thereby retaining the input unit 4 within the accommodating chamber 33.

An operating member 63, which is formed from a resilient material, such as plastic, is mounted on the outer side wall of the housing 21 of the PDA main body 2. The operating member 63 has a fastening portion 631 fastened to the housing 21, and a depressing button 632 exposed from the housing 21 and disposed adjacent to the radial opening 37 and immediately above the second end portion 615 of the plate body 61. The depressing button 632 is operable to depress the second end portion 615 of the plate body 61 so as to result in turning of the first end portion 610 of the plate body 61 away from the accommodating chamber 33 and against biasing action of the biasing member 62 for moving the plate body 61 to a disengaging position, in which the retaining projection 613 is disengaged from the retaining groove 463 in the input unit 4, thereby enabling the input unit 4 to eject from the accommodating chamber 33 by virtue of the biasing action of the biasing unit 5.

Referring to FIG. 8, due to the biasing action of the biasing member 62, the first end portion 610 of the plate body 61 is normally moved toward the accommodating chamber 33 to dispose the plate body 61 in the engaging position where the retaining projection 613 engages the retaining groove 463 when the input unit 4 is received in the accommodating chamber 33, thereby retaining the input unit 4 in the accommodating chamber 33. At this time, the biasing unit 5 is compressed, and stores a restoring energy therein.

Referring to FIG. 9, when the depressing button 632 is depressed, the plate body 61 is turned about an axis of the pivot shafts 611 in a clockwise direction to disengage the retaining projection 613 from the retaining groove 463. Upon disengagement, the input unit 4 is ejected from the accommodating chamber 33 via the open end 44 and the access hole 212 of the housing 21 due to the restoring energy released by the biasing unit 5.

After removal of the input unit 4 from the housing 21 of the PDA main body 2, the input unit 4 is adjustable between the non-extended and extended positions, as shown in FIGS. 6 and 7, by simply applying a pulling or pushing force to move the slide sleeve 42 slidably relative to the main input body 41 so as to engage the positioning protrusions 453 with a selected pair of the first and second positioning grooves 464, 465.

While the present invention has been described in connection with what is considered the most practical and preferred embodiment, it is understood that this invention is not limited to the disclosed embodiment but is intended to cover various arrangement included within the spirit and scope of the broadest interpretation so as to encompass all such modifications and equivalent arrangements.

We claim:

1. An input device for an electronic appliance which has an outer side wall formed with an access hole, comprising:
an accommodating unit confining an elongated accommodating chamber and adapted to be mounted within the electronic appliance such that said accommodating chamber is aligned and communicated with the access hole;
an input unit received removably in said accommodating chamber of said accommodating unit;
a biasing unit mounted in said accommodating unit for biasing said input unit to move in a direction outwardly of said accommodating chamber; and
a retaining unit mounted on said accommodating unit, said retaining unit being normally disposed in an engaging position in which said retaining unit engages said input unit when said input unit is received in said accommodating chamber for retaining said input unit in said accommodating chamber against biasing action of said biasing unit, said retaining unit being operable to move from said engaging position to a non-engaging position, in which said retaining unit is disengaged from said input unit to permit ejection of said input unit from said accommodating chamber due to the biasing action of said biasing unit.

2. The input device as claimed in claim 1, wherein said input unit has an outer surface formed with a retaining groove, said retaining unit having a retaining projection which engages said retaining groove when said retaining unit is in said engaging position while said input unit is received in said accommodating chamber.

3. The input device as claimed in claim 2, wherein said accommodating unit includes a tubular casing that confines said accommodating chamber, said tubular casing being formed with a radial opening communicated with said accommodating chamber, said retaining unit being mounted in said radial opening and including a plate body with opposite first and second end portions and an intermediate portion pivoted to said casing, said retaining projection being formed on said first end portion of said plate body, said retaining unit further including a biasing member for biasing said first end portion of said plate body to move into accommodating chamber, thereby disposing said retaining unit in the engaging position.

4. The input device as claimed in claim 3, wherein said biasing member normally abuts against said first end portion of said plate body to dispose said retaining unit in the engaging position.

5. The input device as claimed in claim 4, further comprising an operating unit adapted to be mounted on the outer side wall of the electronic appliance, said operating unit being operable for moving said first end portion of said plate body away from said accommodating chamber to dispose said retaining unit in the non-engaging position.

6. The input device as claimed in claim 5, wherein said operating unit includes a depressing button disposed adjacent to said radial opening and said second end portion of said plate body, said depressing button being operable to depress said second end portion of said plate body against biasing action of said biasing member to enable turning of said plate body so as to disengage said retaining projection at said first end portion of said plate body from said retaining groove in said input unit.

7. The input device as claimed in claim 1, wherein said input unit is a touch pen.

8. The input device as claimed in claim 1, wherein said input unit is telescopic.

9. The input device as claimed in claim 8, wherein said input unit is a touch pen and includes an elongated main input body with a front section that has a front end formed with a touch portion, and a rear section extending coaxially and rearwardly from said front section, said input unit further including a slide sleeve which is sleeved slidably on said rear section of said main input body, said slide sleeve being slidable axially on said rear section toward said front section for moving to a non-extended position in which said input unit is defined with a shortest length, said slide sleeve being further slidable axially on said rear section away from said front section for moving to an extended position, in which said input unit is defined with a longest length.

10. The input device as claimed in claim 9, wherein said input unit includes positioning means for positioning said slide sleeve in said non-extended position and for positioning said slide sleeve in said extended position.

11. The input device as claimed in claim 10, wherein said slide sleeve has an inner surface disposed around said rear section of said main input body, said positioning means including a first positioning groove formed in said inner surface, a second positioning groove formed in said inner surface and displaced from said first positioning groove in an axial direction of said main input body, and a positioning protrusion formed on said rear section of said main input body for engaging releasably a selected one of said first and second positioning grooves so as to position said slide sleeve at a selected one of said non-extended and extended positions.

12. The input device as claimed in claim 11, wherein said rear section of said main input body has a tubular rear distal end opposite to said touch portion in the axial direction of said main input body, said distal end being formed with a plurality of axially extending slits which impart resiliency in radial directions to said distal end and which configure said distal end with a number of resilient strips, said positioning protrusion being formed on one of said resilient strips.

13. The input device as claimed in claim 12, wherein said positioning protrusion has two inclined surfaces that are inclined with respect to an axis of said main input body and that are opposite to each other along the axis of said main input body, said inner surface of said slide sleeve being slidable past one of said inclined surfaces for disengaging said positioning protrusion from said first positioning groove when said slide sleeve is moved from the non-extended position toward the extended position, said inner surface of said slide sleeve being slidable past the other one of said inclined surfaces for disengaging said positioning protrusion from said second positioning groove when said slide sleeve is moved from the extended position toward the non-extended position.

14. The input device as claimed in claim 9, wherein said rear section of said main input body has an outer surface formed with an axially extending guiding groove with a closed rear end, said slide sleeve having a front end and an inner surface which confronts the outer surface of said rear section and which is formed with a guiding block that extends into said guiding groove and that is slidable along said guiding groove when said slide sleeve is moved between the non-extended position and the extended position, said guiding block engaging said rear end of said guiding groove to prevent removal of said slide sleeve from said main input body when said slide sleeve is moved from the non-extended position to the extended position.

15. An electronic appliance comprising:
a main body having an outer side wall formed with an access hole;
an accommodating unit mounted within said main body, said accommodating unit confining an elongated accommodating chamber that is aligned and communicated with said access hole;
an input unit received removably in said accommodating chamber of said accommodating unit;
a biasing unit mounted in said accommodating unit for biasing said input unit to move in a direction outwardly of said accommodating chamber; and
a retaining unit mounted on said accommodating unit, said retaining unit being normally disposed in an engaging position in which said retaining unit engages said input unit when said input unit is received in said accommodating chamber for retaining said input unit in said accommodating chamber against biasing action of said biasing unit, said retaining unit being operable to move from said engaging position to a non-engaging position, in which said retaining unit is disengaged from said input unit to permit ejection of said input unit from said accommodating chamber due to the biasing action of said biasing unit.

16. The electronic appliance as claimed in claim 15, wherein the electronic appliance is a personal digital assistant, and said input unit is a touch pen.
